(19) United States
(12) Patent Application Publication
(10) Pub. No.: US 2001/0052025 A1
(43) Pub. Date: Dec. 13, 2001

(54) Router setting method and router setting apparatus

(75) Inventor: Keiji Maeda, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/875,873

(22) Filed: Jun. 8, 2001

(30) Foreign Application Priority Data
Jun. 9, 2000 (JP) 174493/2000

(51) Int. Cl. G06F 15/173; H04L 12/28; H04L 12/56

(52) U.S. Cl. 709/238; 370/392

(57) ABSTRACT

A method for setting routers is provided which is capable of making a same setting to a plurality of routers in a communication path by transmitting a single IP packet from a transmitter.

In a router setting method in which control information is set to a plurality of routers mounted in a network to which a plurality of terminals is connected and operated to control, by being disposed among a plurality of terminals, communication among terminals, contents requesting for replication of a payload are added to the IP packet transmitted from a terminal of a transmitter, the payload is replicated by a router in accordance with the request, control information is set to the router in accordance with a replicated payload and the IP packet is transmitted to a next router or terminal.

### BACKGROUND OF THE INVENTION

1. Field of the Invention

The present invention relates to a router setting method and a router setting apparatus which, in transmission from one terminal connected to a network to an other terminal connected to the network, enables control setting required for communication between the one terminal and the other terminal to a plurality of routers being disposed between the one terminal and the other terminal by transmitting a single packet from the one terminal on a transmitter side.

The present application claims priority of Japanese Patent Application No. 2000-174493 filed on Jun. 9, 2000, which is hereby incorporated by reference.

2. Description of the Related Art

To carry out communication among terminals using a wide area network such as the Internet, a communication control apparatus called a router is required. The router performs routing of data (packet) to be transmitted by monitoring an IP (Internet Protocol) address of a transmitter and a destination. Conventionally, a best-effort type router so configured as to make no difference in processing of packets to be transferred has been mainstream. Therefore, when the network becomes busy, a quality related to a delay, to a band in communication, and to priority over other packets has not been guaranteed.

However, in recent years, services guaranteeing such qualities are being provided including an IntServ (Integrated Services), DiffServ (Differentiated Service) or a like. These services have been investigated by the IETF (Internet Engineering Task Force) and described in the RFC (Request For Comments).

Each of the routers installed in communication paths has control information being different depending on types of the router. Therefore, in order to guarantee qualities in the communication paths, it is necessary to individually provide control information to each of the routers installed in the communication paths. In some cases, to maintain the quality at a constant level in the communication path, the same setting request is made in all routers on the communication path. As a method for performing such the setting request, a method is known in which an individual IP packet is transmitted to each of the routers in the communication path or in which a multicast address is assigned to routers installed in the communication paths.

However, the method in which the IP packet is transmitted individually to each of the routers in the communication paths presents a problem in that, since the IP packets are produced in proportion to the number of the routers to which the control information is provided, traffics on the network are increased. Moreover, the method in which the multicast address is assigned to routers installed in the communication paths also presents a problem in that transmission to make a request for setting so as to have a packet used to assign an address and a multicast address as a destination address is required, thus causing the increase in traffics on the network and requesting the router to have a plurality of multicast addresses for every communication path.

### SUMMARY OF THE INVENTION

In view of the above, it is an object of the present invention to provide a router setting method and a router setting apparatus capable of performing same setting to a plurality of routers existing in a communication path only by transmitting a single IP packet from a transmitter.

According to a first aspect of the present invention, there is provided a method for setting routers for making a setting of control information to a plurality of routers mounted on a network to which a plurality of terminals is connected and adapted to control, by being disposed among terminals, communication among terminals including:

a step of adding contents requesting for replication of a payload to a packet transmitted from a terminal of a transmitter and of performing replication of the payload using the router in accordance with the request;

a step of making a setting of the control information in accordance with replicated payload; and

a step of transmitting the packet to a next router or a terminal.

With the above configuration, in the router in which the setting of control information necessary for communication is required, the payload is replicated in accordance with the request for replication of the payload of the packet. Then, based on the replicated payload, the specified control information is set to the router. Therefore, it is not necessary to use multicast addresses for routers existing in the communication path or to transmit the packet to each of the routers and it is possible to set the control information by transmitting a single packet from the transmitter.

In the foregoing, a preferable mode is one wherein the packet is an IPv6 (Internet Protocol Version 6) packet and wherein contents requesting for replication of the payload are contained in an expanded header of the IPv6 packet.

With another configuration, the IPv6 packet is provided which represents a next generation protocol developed mainly to expand address space and to reduce a routing load and which is a packet described in the RFC. The IPv6 packet has an expansion header and various options can be set in the IPv6 packet. Therefore, by using the expanded optional functions, it is made possible to make a request for replicating the payload to a specified router.

Also, a preferable mode is one wherein processing of the IPv6 packet in the router includes;

a step of judging whether a Hop-By-Hop option exists in the expanded header;

a step of judging, when the Hop-By-Hop option exists, a type of the Hop-By-Hop option; and

a step of performing, when the Hop-By-Hop option is a predetermined-option type, replication of a payload.

With another configuration, whether the payload replication to the specified router is performed can be judged, for example, based on the type of Hop-By-Hop option. Moreover, whether the payload replication is performed or not may be judged by checking if the destination address contained in the IPv6 header format is the address of its own router or of other router and based on the type of the destination option header.

Also, a preferable mode is one wherein the IPv6 packet in the router includes:

a step of judging whether a destination address contained in an IPv6 header format is an address of the router or of an other router, a step of judging, when the destination address is the address of the router, whether a destination option header contained in the expanded header exists;

a step of judging, when the destination option header exists, a type of the destination option header; and

a step of performing, when the option is the predetermined option type, replication of the payload.

According to a second aspect of the present invention, there is provided a router setting apparatus for making a setting of control information to a plurality of routers mounted on a network to which a plurality of terminals is connected and adapted to control, by being disposed among terminals, communication among terminals including:

a payload retrieving section used to retrieve a payload required for being replicated from packets input from an input interface section of a router;

a payload replicating section used to replicate the payload when the payload requiring for being replicated is judged by the payload retrieving section to exist; and

a control information setting section used to set predetermined control information to the router in accordance with the payload replicated by the payload replicating section.

With the above configuration, the payload retrieving section checks whether there is a request for replication of the payload. Then, if the replication request is found by the payload retrieving section, the payload replicating section replicates the payload. Based on the replicated payload, the control information setting section sets the control information to the router. In this case, the IPv6 packet being the next generation protocol may be used. Therefore, also in this case, it is not necessary to use the multicast addresses or to transmit the packet to each router and the setting to a plurality of routers existing on the communication paths among terminals can be implemented only by transmitting a single packet.

In the forgoing, a preferable mode is one wherein the packet is an IPv6 packet and wherein the payload retrieving section checks existence of a replication request based on an expanded header of the IPv6 packet.

Therefore, with the present invention, when it is requested that the same control information is set to routers arranged in a communication path, even if the number of the routers is plural, setting can be made by transmitting a single packet. Therefore, the setting of the control information to each of the routers is not required, thus eliminating a need for using a multicast address.

### BRIEF DESCRIPTION OF THE DRAWINGS

The above and other objects, advantages, and features of the present invention will be more apparent from the following description taken in conjunction with the accompanying drawings in which:

FIG. 1 is a conceptual diagram explaining a network through which a router setting packet used to set a router passes according to a first embodiment of the present invention;

FIG. 2 is a schematic block diagram showing configurations of the router having an additional IPv6 expanded header processing section shown in FIG. 1;

FIG. 3 is a diagram illustrating a format of an IPv6 header according to the first embodiment of the present invention;

FIG. 4A is a diagram illustrating a configuration of a TVL encoded format 30 according to the first embodiment of the present invention;

FIG. 4B is a diagram illustrating a configuration of a packet replicating option 31 according to the first embodiment of the present invention;

FIG. 5 is a diagram showing an example in which the packet replicating option is set to a Hop-By-Hop option header according to the first embodiment of the present invention;

FIG. 6 is a flowchart explaining processing performed by the additional IPv6 expanded header processing section on one IPv6 packet according to the first embodiment of the present invention;

FIG. 7 is a diagram explaining configurations of a Hop-By-Hop option header according to a second embodiment of the present invention; and

FIG. 8 is a flowchart explaining processing performed by the additional IPv6 expanded header processing section on one IPv6 packet according to the second embodiment of the present invention.

### DETAILED DESCRIPTION OF THE PREFERRED EMBODIMENTS

Best modes of carrying out the present invention will be described in further detail using various embodiments with reference to the accompanying drawings.

### First Embodiment

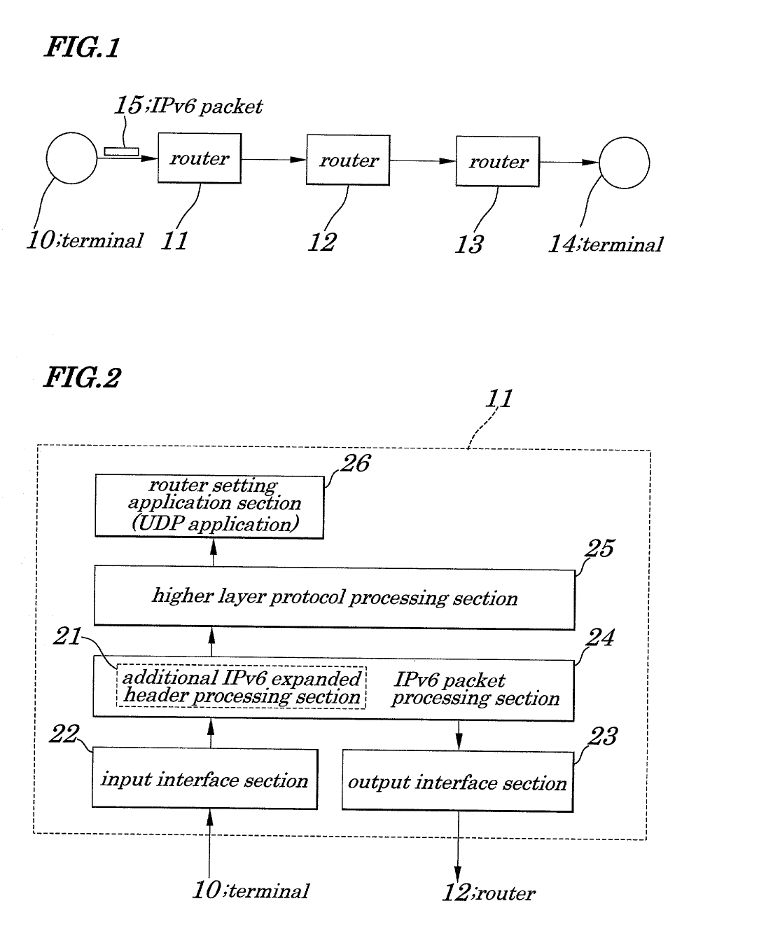

FIG. 1 is a conceptual diagram explaining a network through which a router setting packet used to set a router passes according to a first embodiment of the present invention. In a communication path between a terminal 10 of a transmitter and a terminal 14 of a destination (a receiver) is provided a plurality of routers 11, 12, and 13. In the embodiment, an IP packet used to set routers to be transmitted from the terminal 10 of the transmitter is an IPv6 (Internet Protocol Version 6) packet 15. The IPv6 packet 15 is made up of an IPv6 header, an IPv6 expanded header, and a payload. The IPv6 expanded header contains an option (a packet replicating option) used to make a request for replicating the payload and to pass it on to a higher layer. The payload contains contents of control setting to each of the routers 11 to 13. The routers 11 to 13 to which the setting is made have functions of replicating the payload to perform processing of the packet replicating option. From the terminal 10 is transmitted the IPv6 packet 15 used for setting of the routers 11 to 13 on which the IPv6 address is set up as a destination address. Each of the routers 11 to 13 receives the IPv6 packet 15 transmitted from the terminal 10 or the router 11 to 13 existing at a front stage and processing of setting the routers 11 to 13 is performed in accordance with the packet replicating option. Moreover, at the same time, the router 11, in accordance with a routing header contained in the expanded header or path information set in advance according to the routing protocol or set manually, transfers the IPv6 packet 15 to the router 12. Thereafter, in the same manner, the router 12 transfers the IPv6 packet 15 to the router 13. Finally, the router 13 transfers the IPv6 packet 15 to the terminal 14.

FIG. 2 is a schematic block diagram showing configurations of the routers 11 to 13 shown in FIG. 1. Since basic configurations of each of the routers 11 to 13 are the same, only the router 11 is described and descriptions of other routers 12, 13 will be omitted accordingly. The router 11 chiefly includes an input interface section 22 used to receive the IPv6 packet 15 transmitted from the terminal 10, an output interface section 23 used to transmit the IPv6 packet 15 to the next router 12, an IPv6 packet processing section 24 used to perform processing of the IPv6 packet, an additional IPv6 expanded header processing section 21 mounted in the IPv6 packet processing section 24 used to perform processing of the expanded header of the IPv6 packet 15, a higher layer protocol processing section 25, and a router setting application section 26.

The input interface section 22 is made up of one or more interfaces and is used to perform processing of contents of a protocol contained in a layer being lower than the IPv6 packet 15 and has a function of passing the IPv6 packet 15 transmitted to the router 11 from the terminal 10 or the router existing at the front stage on to the IPv6 packet processing section 24. The additional IPv6 expanded header processing section 21 contained in the IPv6 packet processing section 24 monitors Hop-by-Hop option headers of all IPv6 packets 15 to be transmitted from the input interface section 22 to the IPv6 packet processing section 24. Then, the additional IPv6 expanded header processing section 21, if an option type is a predetermined number, replicates the payload of the IPv6 packet 15 input from the input interface section 22 and performs processing of passing the replicated payload on to the higher layer protocol processing section 25. That is, according to the first embodiment, the additional IPv6 expanded header processing section 21 serves as a payload retrieving section used to retrieve the payload that is required to be replicated and, when the payload is judged by the payload retrieving section to exist, serves as a payload replicating section to replicate the payload.

The output interface section 23 is made up of one or more interfaces and has functions of processing contents of a protocol contained in a layer being lower than the IPv6 packet 15 and of transmitting the IPv6 packet 15 that is required by the IPv6 packet processing section 24 to be output to the router 12 at the next stage. The IPv6 packet processing section 24 performs processing designated in RFC2460 issued by IETF on the IPv6 packet 15.

The higher layer protocol processing section 25 performs processing of contents of a layer (hereinafter referred to as an IPv6 higher layer protocol) defined in the RFC 2460. The IPv6 higher layer protocol contains, for example, a TCP (Transmission Control Protocol) being a transport protocol, UDP (User Datagram Protocol), ICMP (Internet Control Message Protocol) being a control protocol or a like.

The router setting application section 26 has a router setting application used to support the IPv6 higher layer protocol. The router setting application of the embodiment is a UDP application to a UDP packet from a specified port number of the UDP. The router setting application section 26 makes a setting of specified contents for control to the router 11 based on processing results of the higher layer protocol processing section 25. That is, according to the first embodiment, the router setting application section 26 makes up a control information setting section.

Next, operations of the IPv6 packet 15 are explained below. The IPv6 packet 15 is made up of an IPv6 header, IPv6 expanded header, and a payload containing common setting contents (control information for routers 11 to 13 to be passed through) described in the RFC2460. In the IPv6 expanded header in the IPv6 packet 15 always exists the Hop-By-Hop option header containing a packet replicating option 31 (see FIG. 4B).

FIG. 4A is a diagram illustrating a configuration of a TVL encoded format 30 according to the first embodiment of the present invention. Also, FIG. 4B is a diagram illustrating a configuration of a packet replicating option 31 according to the same embodiment.

In ordinary cases, a TLV (Type-Length-Value) encoder described in the RFC2460 is made up of an area of an option type, an area of an option data length, and an area of an option data. The packet replicating option 31 of the first embodiment, as shown in FIG. 4A, has no area of the option data in accordance with a TVL encoded format 30.

In the first embodiment, a value X for the option type (8 bits) making up the packet replicating option 31 is designated in advance as follows. In the IPv6 packet 15, since there is no need for being processed at the terminal 14 (destination), bits other than “00”, in which case the packet is abandoned when contents of the option type cannot be interpreted by the terminal 14, are set to higher two bits in the option type area.

In the first embodiment, since contents in the option header area are not changed, “1” is assigned to a higher third bit. The number is used for lower five bits in a manner that the number used for the lower five bits and the number used other option do not overlap. For example, if “01” are used for the higher two bits and “11111” are used for the lower five bits, a value of X becomes “01111111”. FIG. 5 is a diagram showing an example in which the packet replicating option 31 is set to the Hop-By-Hop option according to the first embodiment of the present invention. Since a Hop-By-Hop option header 40 is in a unit of eight octets in length, a PadN option for adjusting the length is inserted.

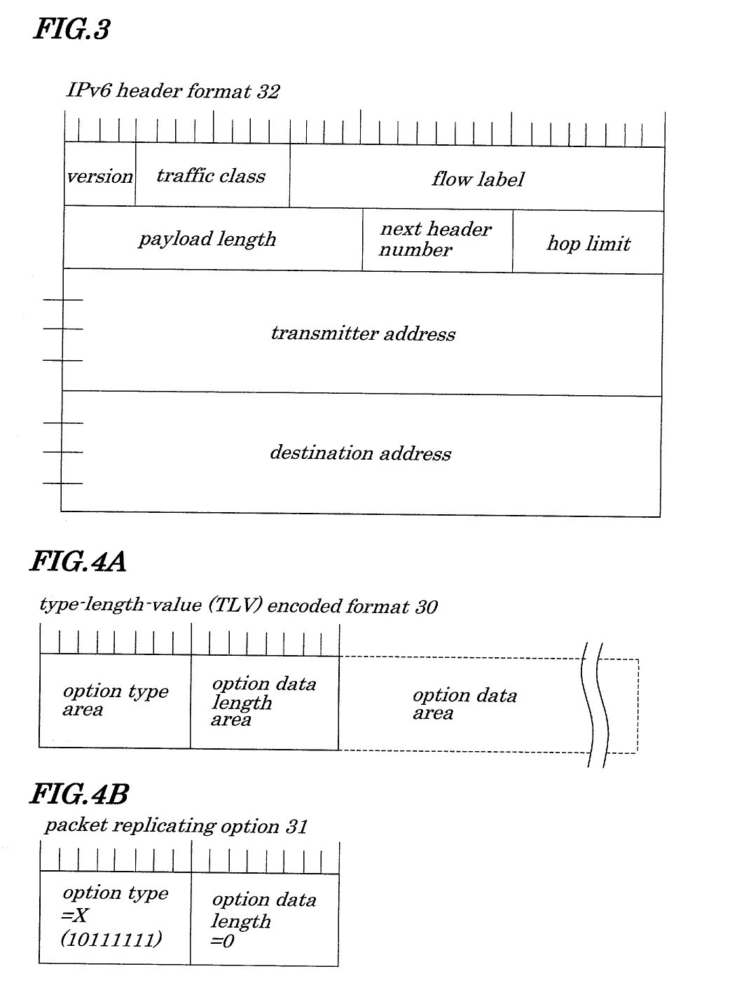

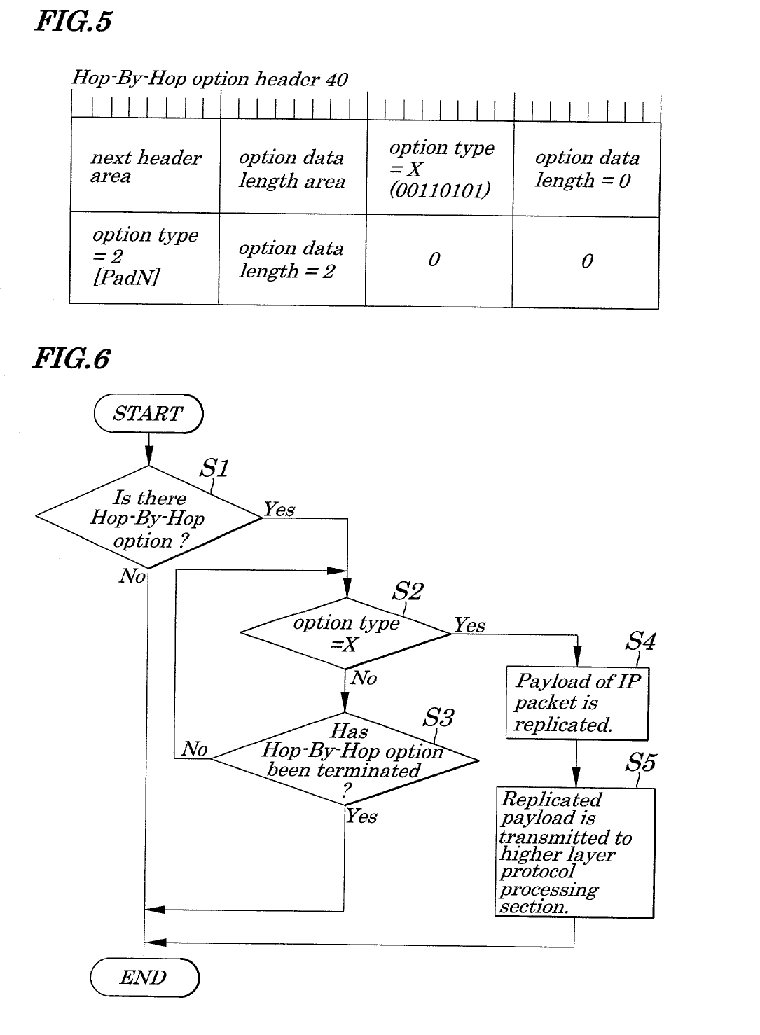

Next, operations of the additional IPv6 expanded header processing section 21 will be described by referring to FIGS. 3 to 6. FIG. 6 is a flowchart explaining processing performed by the additional IPv6 expanded header processing section 21 on one IPv6 packet according to the first embodiment of the present invention. The additional IPv6 expanded header processing section 21 judges existence of the Hop-By-Hop option header 40 depending on whether a value of the next header number of an IPv6 header shown in FIG. 3 is “0” representing the Hop-By-Hop option header 40 (Step S1). When a value of the next header number is “0”, processing in Step S2 is performed.

According to the RFC2460, since it is designated that the Hop-By-Hop option header 40 is placed immediately after the IPv6 header, if the value of the next header number of the IPv6 header is not “0”, the processing is terminated. In Step S1, if existence of the Hop-By-Hop option header 40 is confirmed, whether the packet replicating option 31 is contained in the Hop-By-Hop option header 40 or not is judged. Whether the packet replicating option 31 is contained or not is judged based on existence of a field in which the option type of the Hop-By-Hop option header 40 is a value of X that has been predetermined.

Since a plurality of option types is contained in the Hop-By-Hop option header 40, until processing of all options existing in the Hop-by-Hop option header 40 is terminated, procedures in Step S2 are repeated. When the packet replicating option 31 does not exist in the Hop-by-Hop option header 40, the processing is terminated (Step S3). In Step S2, when the packet replicating option 31 is found in the Hop-By-Hop option header 40, the packet is recognized to be a packet for setting the router. In Step S4, the payload of the IPv6 packet in which contents for setting to the router are contained is replicated. In Step S5, the replicated payload is transmitted to the higher layer protocol processing section 25.

By procedures described above, the additional IPv6 expanded header processing section 21 replicates the payload of the IPv6 packet 15 to be transferred to a next stage and passes it on to the higher layer protocol processing section 25. The higher layer protocol processing section 25 processes the replicated payload. Predetermined control information is set to the router 11 by processing of the router setting application section 26 based on results from the processing performed by the higher layer protocol processing section 25.

### Second Embodiment

Configurations and operations of routers of a second embodiment are the same as those in the first embodiment, except operations of an additional IPv6 expanded header processing section 21, and descriptions of those components will be omitted accordingly.

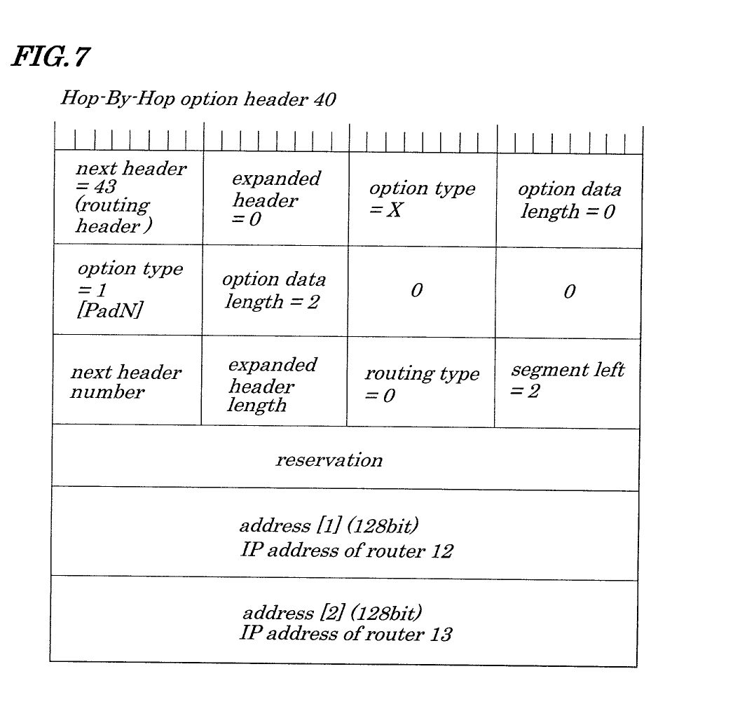

FIG. 7 is a diagram explaining configurations of a Hop-By-Hop option header 40 according to a second embodiment of the present invention. According to operations in the second embodiment, in network configurations shown in FIG. 1, if a terminal 10 used to transmit a router setting packet, IPv6 packet 15, has already known an IP address of routers 11 to 13 through which an IP packet is transmitted to IP addresses of a terminal 14 of a transmitter, as shown in FIG. 7, a packet replicating option 31 is set to a destination option header by using destination addresses as the IP address of the router 11 at a next stage and by combining those with a routing header and destination header.

The additional IPv6 expanded header processing section 21 monitors a destination address of a IPv6 header (see IPv6 header format 32 shown in FIG. 3) and a destination option header contained in the IPv6 expanded header in the IPv6 packet 15 to be transmitted from an input interface section 22 to an IPv6 packet processing section 24 and, if a packet replicating option is contained in the destination option header, replicates a payload of the IPv6 packet 15 input from the input interface section 22 and performs processing of passing the payload of the IPv6 packet 15 on to the higher layer protocol processing section 25.

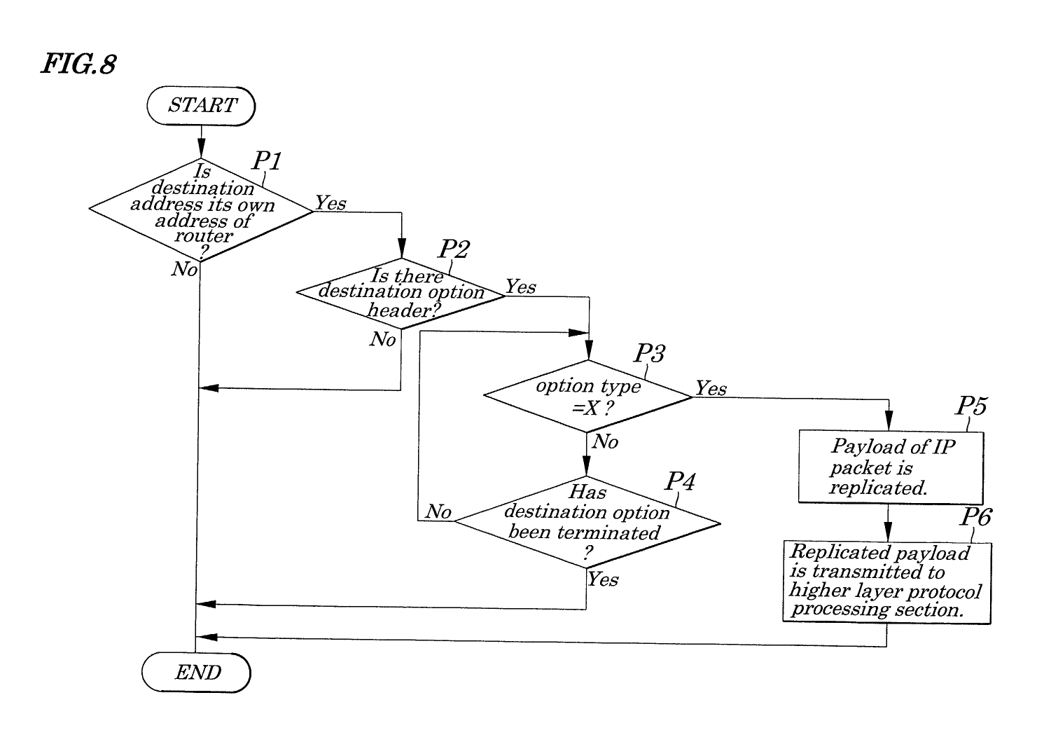

FIG. 8 is a flowchart explaining a processing performed by the IPv6 expanded header processing section 21 on one IPv6 packet 15 according to the second embodiment of the present invention. The additional IPv6 expanded header processing section 21 of the router 11 judges whether the destination address of the IPv6 header format 32 shown in FIG. 3 is its own address, that is, the address of the router 11 or not (Step P1 in FIG. 8). When the destination address is its own address, that is, the address of the router 11, a routine proceeds to Step P2. If the destination address is an address of an other router, processing is terminated.

When it has been confirmed that the processing of the destination option header is required, whether the packet replicating option 31 is contained in the destination option header or not is judged, based on whether option type is a predetermined X (Step P3). Since the destination option header, as in the case of a Hop-By-Hop option header, can contain a plurality of options, the processing in Step P3 is performed on all options of the destination option header (Step P4).

In Step P3, when a field in which a value of the option type becomes X is found in a destination option header, a packet is recognized to be a router setting requesting packet. Then, the payload of the IPv6 packet 15 containing contents of setting requests to the router is replicated (Step P5) and the replicated payload is transmitted (Step P6).

By taking procedures described above, as in the case of the first embodiment, by using the expanded header not by employing multicast addresses at the terminal 10, the same setting can be made to a plurality of routers existing in the predetermined path not by transmitting a plurality of packets but by transmitting the single IPv6 packet 15.

It is apparent that the present invention is not limited to the above embodiments but may be changed and modified without departing from the scope and spirit of the invention. For example, in the above embodiments, as the IP packet, the IPv6 packet is employed, however, an other packet such as an Ipv4 packet may be used. Moreover, in the above embodiments, the destination option header is used, however, a routing header and/or fragment header may be used. In addition to these headers, a new option header may be defined and the newly defined option header may be used.

What is claimed is:

1. A method for setting routers for making a setting of control information to a plurality of routers mounted on a network to which a plurality of terminals is connected and adapted to control, by being disposed among terminals, communication among terminals comprising:
a step of adding contents requesting for replication of a payload to a packet transmitted from a terminal of a transmitter and of performing replication of said payload using said router in accordance with said request;
a step of making a setting of said control information in accordance with replicated payload; and
a step of transmitting said packet to a next router or a terminal.

2. The method for setting routers according to claim 1, wherein said packet is an IPv6 (Internet Protocol Version 6) packet and wherein contents requesting for replication of said payload are contained in an expanded header of said IPv6 packet.

3. The method for setting routers according to claim 2, wherein processing of said IPv6 packet in said router includes;
a step of judging whether a Hop-By-Hop option exists in said expanded header;
a step of judging, when said Hop-By-Hop option exists, a type of said Hop-By-Hop option; and
a step of performing, when said Hop-By-Hop option is a predetermined-option type, replication of said payload.

4. The method for setting routers according to claim 2, wherein said IPv6 packet in said router includes:
a step of judging whether a destination address contained in an IPv6 header format is an address of said router or of an other router,
a step of judging, when said destination address is said address of said router, whether a destination option header contained in said expanded header exists;
a step of judging, when said destination option header exists, a type of said destination option header; and
a step of performing, when said option is a predetermined-option type, replication of said payload.

5. A router setting apparatus for making a setting of control information to a plurality of routers mounted on a network to which a plurality of terminals is connected and adapted to control, by being disposed among terminals, communication among terminals comprising:
a payload retrieving section used to retrieve a payload required for being replicated from packets input from an input interface section of a router;
a payload replicating section used to replicate said payload when said payload requiring for being replicated is judged by said payload retrieving section to exist; and
a control information setting section used to set predetermined control information to said router in accordance with said payload replicated by said payload replicating section.

6. The router setting apparatus according to claim 5, wherein said packet is an IPv6 packet and wherein said payload retrieving section checks existence of a replication request based on an expanded header of said IPv6 packet.

7. A router setting apparatus for making a setting of control information to a plurality of routers mounted on a network to which a plurality of terminals is connected and adapted to control, by being disposed among terminals, communication among terminals comprising:
a payload retrieving means used to retrieve a payload required for being replicated from packets input from an input interface means of a router;
a payload replicating means used to replicate said payload when said payload requiring for being replicated is judged by said payload retrieving means to exist; and
a control information setting means used to set predetermined control information to said router in accordance with said payload replicated by said payload replicating means.

8. The router setting apparatus according to claim 7, wherein said packet is an IPv6 packet and wherein said payload retrieving means checks existence of a replication request based on an expanded header of said IPv6 packet.
